(19) United States
(12) Patent Application Publication
(10) Pub. No.: US 2015/0066754 A1
(43) Pub. Date: Mar. 5, 2015

(54) METHOD AND SYSTEM FOR PAYMENT SERVICE

(71) Applicant: NHN Entertainment Corporation, Seongnam-si (KR)

(72) Inventors: Seong Bong HONG, Seongnam-si (KR); Hyun Gu KIM, Seongnam-si (KR); Jin Woong LEE, Seongnam-si (KR)

(21) Appl. No.: 14/465,081

(22) Filed: Aug. 21, 2014

(30) Foreign Application Priority Data
Sep. 3, 2013 (KR) 10-2013-0105425

(51) Int. Cl. G06Q 20/10

(52) U.S. Cl. CPC G06Q 20/102
USPC 705/40

(57) ABSTRACT

Provided is a method and system for a payment service. A payment service method embodied in a computer to provide a payment service may include registering and maintaining a product in a product database for each service, with respect to a plurality of services, creating billing information of a requested product in response to a call of an application program interface (API) of a service for which a product purchase is requested from a user, using the product database, and providing the billing information to a market associated with the user. Here, a payment according to the product purchase may be processed at the market based on the billing information.

### CROSS-REFERENCE TO RELATED APPLICATION

This application claims priority from and the benefit of Korean Patent Application No. 10-2013-0105425, filed on Sep. 3, 2013, which is hereby incorporated by reference for all purposes as if fully set forth herein.

### BACKGROUND

1. Field

The present disclosure relates to a method and system for a payment service.

2. Description of Related Art

A service provided through, for example, a game and an application may need to process a payment using a variety of methods based on the type of service. For example, various types of products, such as items, cyber money, coupons, and providing of information, may be sold through a service. When a user desires to purchase a product, a payment may need to be processed using a variety of methods in response to the product purchase of the user.

FIG. 1 is a diagram illustrating a product payment process according to related art. A mobile terminal 110, an application 120, a service server 130, a plurality of markets 140, for example, a first market, a second market, and a third market, and a plurality of services 150, for example, a first payment service, a second payment service, and a third payment service, are illustrated in FIG. 1. A user may be provided with a service in communication with the service server 130, through the application 120 installed in the mobile terminal 110, and may purchase a product provided through the service. In the related art, a separate payment system needs to be constructed for each service, with respect to a plurality of services and a separate payment service needs to be provided for each service. Referring to FIG. 1, a payment of a product that the user desires to purchase may be processed through a correlation between the third market associated with the user among the plurality of markets 140 and the first payment service separately constructed and provided for the application 120 among the plurality of payment services 150. In addition, managing a payment may indicate managing all the complex processes, for example, management of a product such as an item or a service to be provided, management of product sales information, management about an individual payment transaction, market management, product delivery, payment verification, management of payment information, and a payment limit or payment agreement verification. Accordingly, managing a payment may consume considerable resources in providing a service.

In the related art, individual service developers may need to directly construct a payment system and provide a payment service and thus, may not solely concentrate on the development of a service to be provided.

### SUMMARY

Embodiments of the present disclosure provide a method and system for a payment service that enables a service to call an application program interface (API) for payment and thereby simply process a product payment, without a need to construct a separate payment system for each service, by constructing a payment system capable of integrally processing a payment related process with respect to a variety of services, and by providing the API to developers.

Additional features will be set forth in the description which follows, and in part will be apparent from the description, or may be learned by practice of the disclosure.

Embodiments disclose a payment service method embodied in a computer to provide a payment service, the method comprising registering and maintaining a product in a product database for each service, with respect to a plurality of services, creating billing information of a requested product in response to a call of an API of a service for which a product purchase is requested from a user, using the product database, and providing the billing information to a market associated with the user. A payment according to the product purchase may be processed at the market based on the billing information.

The payment service method may further include storing the billing information or payment information created at the market in a payment history database in association with the service or the user, and creating payment settlement information on the service or the user using the payment history database.

The payment service method may further include providing the payment settlement information in response to a request from a provider of the service or the user.

Embodiments also disclose a payment service method embodied in a computer to provide a payment service, the method comprising providing information on a product to a terminal of a user, receiving a purchase request for the product from the terminal of the user, calling an API associated with a payment service server in response to the purchase request, and receiving payment information created by processing the purchase request at a market associated with the user. The payment information may be created at the market based on billing information that is created at the payment service server using a product database in response to the call of the API, and a product may be registered and maintained in the product database for each service, with respect to a plurality of services.

Embodiments also disclose a payment service system, comprising a storage unit/storage configured to store a product database in which a product is registered and maintain for each service, with respect to a plurality of services, and at least one processor. The at least one processor may perform a process of creating billing information of a requested product in response to a call of an API of a service for which a product purchase is requested from a user, using the product database, and a process of providing the billing information to a market associated with the user. A payment according to the product purchase may be processed at the market based on the billing information.

Embodiments also disclose a payment service system, comprising at least one storage unit/storage configured to store information on a product, and at least one processor. The at least one processor may perform a process of providing information on the product stored in the at least one storage unit to a terminal of a user, a process of receiving a purchase request for the product from the terminal of the user, a process of calling an API associated with a payment service server in response to the purchase request, and a process of receiving payment information created by processing the purchase request at a market associated with the user. The payment information may be created at the market based on billing information that is created at the payment service server using a product database in response to the call of the API, and a product may be registered and maintained in the product database for each service, with respect to a plurality of services.

It is to be understood that both the foregoing general description and the following detailed description are exemplary and explanatory and are intended to provide further explanation of the claimed subject matter.

### EFFECT

According to embodiments, on the side of a service, it is possible to simply process a product payment through call of an application program interface (API) for payment, without a need to construct a separate payment system for each service, by constructing a payment system capable of integrally processing a payment related process with respect to a variety of services, and by providing the API to developers.

### BRIEF DESCRIPTION OF THE DRAWINGS

The accompanying drawings, which are included to provide a further understanding of the disclosure and are incorporated in and constitute a part of this specification, illustrate embodiments of the disclosure, and together with the description serve to explain the principles of the disclosure.

FIG. 1 is a diagram illustrating a product payment process according to a related art.

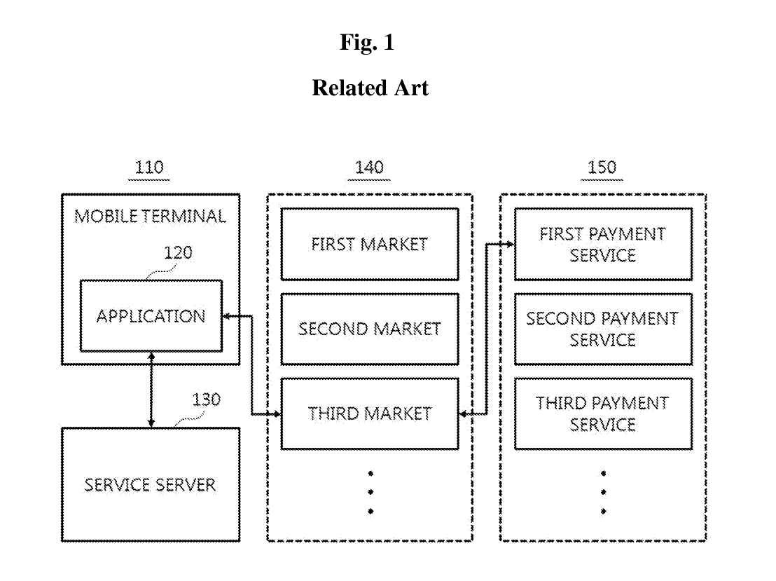

FIG. 2 is a diagram illustrating a payment service system according to example embodiments.

FIG. 3 is a diagram illustrating an example of a payment process according to an embodiment.

FIG. 4 is a flowchart illustrating an example of a payment service method according to an embodiment.

FIG. 5 is a flowchart illustrating another example of a payment service method according to an embodiment.

### DETAILED DESCRIPTION OF THE ILLUSTRATIVE EMBODIMENTS

Embodiments will be described in detail with reference to the accompanying drawings. These embodiments will be described in detail for those skilled in the art in order to practice the present disclosure. It should be appreciated that various embodiments of the present disclosure are different but do not have to be exclusive. For example, specific shapes, configurations, and characteristics described in an embodiment of the present disclosure may be implemented in another embodiment without departing from the spirit and the scope of the present disclosure. In addition, it should be understood that position and arrangement of individual components in each disclosed embodiment may be changed without departing from the spirit and the scope of the present disclosure. Therefore, a detailed description described below should not be construed as being restrictive. In addition, the scope of the present disclosure is defined only by the accompanying claims and their equivalents if appropriate. Similar reference numerals will be used to describe the same or similar functions throughout the accompanying drawings. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

The terminology used herein is for the purpose of describing embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements and/or components, but do not preclude the presence or addition of one or more other features, integers, steps, operations, elements, components, and/or groups thereof.

Hereinafter, embodiments are described in detail with reference to the accompanying drawings.

It will be understood that when an element is referred to as being “connected to” another element, it can be directly connected to the other element, or intervening elements may be present.

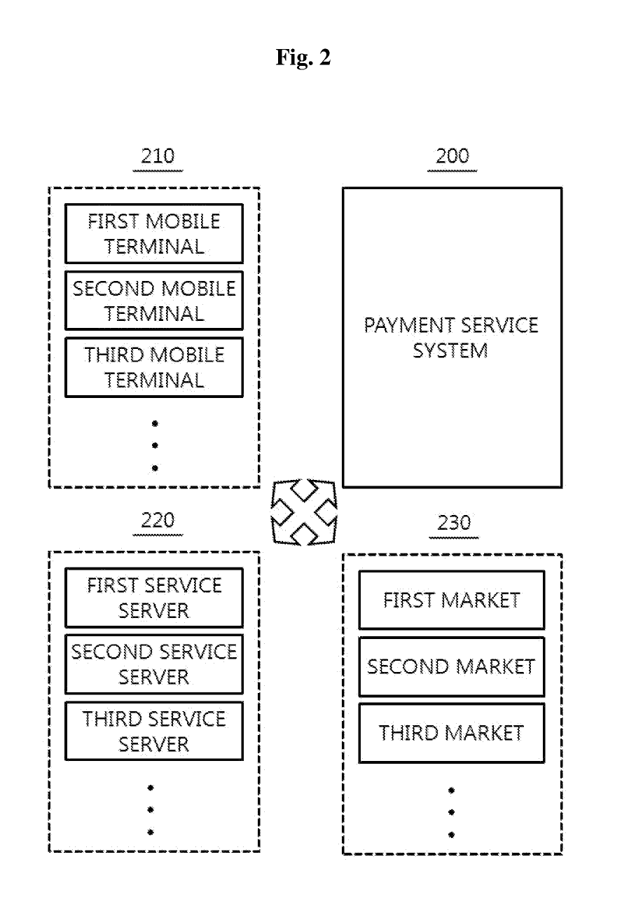

FIG. 2 is a diagram illustrating a payment service system 200 according to an embodiment. The payment service system 200, a plurality of mobile terminals 210, for example, a first mobile terminal, a second mobile terminal, and a third mobile terminal, a plurality of service servers 220, for example, a first service server, a second service server, and a third service server, and a plurality of markets 230, for example, a first market, a second market, and a third market, are illustrated in FIG. 2.

The payment service system 200 may refer to a server capable of providing an integrated payment service with respect to a variety of services. For example, the payment service system 200 may provide a payment service to different game servers that are configured to provide different types of games, respectively.

Developers of services provided to the plurality of mobile terminals 210 may provide information associated with products and payments to the payment service system 200. The payment service system 200 may register and maintain a product for each service, with respect to a plurality of services. On the side of services, a payment of a product may be processed at the payment service system 200 by calling a payment service of the payment service system 200 in response to an occurrence of an event requiring a payment.

As above, developers may process a payment associated with a service desired to be provided using the payment service system 200 without constructing a separate payment system. Accordingly, cost required for the development of the service may be reduced.

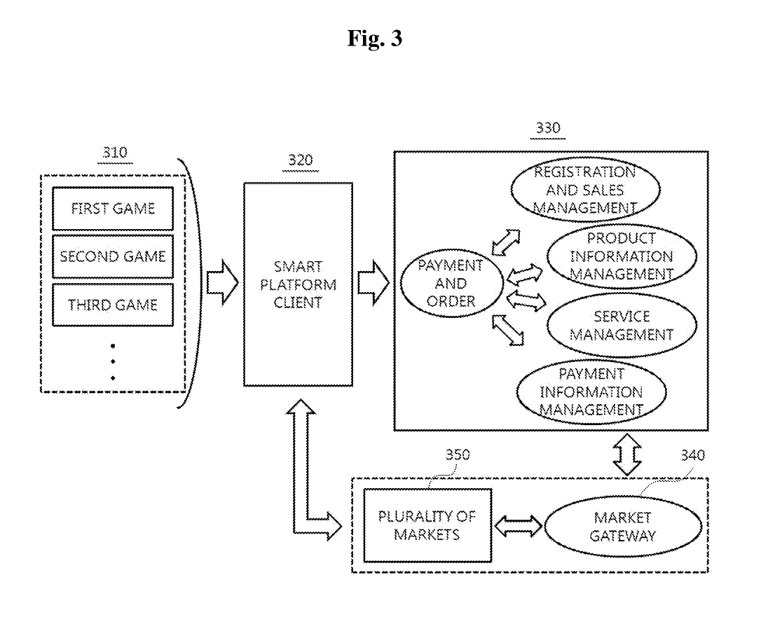

FIG. 3 is a diagram illustrating an example of a payment process according to an embodiment. A plurality of games 310, for example, a first game, a second game, and a third game, a smart platform client 320, a payment service server 330, a market gateway 340, and a plurality of markets 350 are illustrated in FIG. 3. The smart platform client 320 and the payment service server 330 may be included in the payment service system 200 of FIG. 2.

In response to a call of an application program interface (API) for payment from the plurality of games 310, the smart platform client 320 may request the payment service server 330 for payment of a product. For example, when a user of a game service transfers a purchase intent for purchasing a product to a game server, the game server may call the smart platform client 320 using a provided API and a payment of the product may be processed at the payment service server 330 in response to a request from the smart platform client 320.

The payment service server 330 may include, for example, the following modules.

A registration and sales management module may register a product and manage product sales information.

A product information management module may manage product information and may process delivery and non-delivery of a product.

A service management module may correlate information on a service, a product of the service, and a market to one another and thereby manage the same, and may manage a payment claim and a payment service operation.

A payment information management module may perform follow-up management, such as an individual payment and billing management, a transmission of receipt, and payment information, and may verify a payment limit and a user agreement.

A payment and order module may process a payment of a product requested from the smart platform client 320 in interaction with the aforementioned modules.

The payment service server 330 may process billing through connection to a market associated with the payment of the requested product among the plurality of markets 350 through the market gateway 340 and thereby enables the payment of the requested product to smoothly proceed.

As described above, according to embodiments, by supporting an integrated payment of products provided in a variety forms, for example, a service characteristic, an item, cyber money, and a coupon, it is possible to support a service developer to concentrate solely on the development of a service without configuring a separate payment function. For example, a game developer may perform processing associated with a payment of a product by calling an API and thus, may concentrate solely on the development of a service.

Also, security or policy for each market, customer service, for example, providing payment history information on an item, about a product, and claim processing and intervention may be processed on the side of a provider of a payment service according to embodiments.

Also, unless product information is managed for each service, only billing and payment may be provided for each service and thus, it may be difficult to provide an overview of product information. In contrast, a payment service according to embodiments may directly manage product information, for example, a product price and sales of a product and thus, it is possible to provide individual service providers with an automatic settlement function in conjunction with billing.

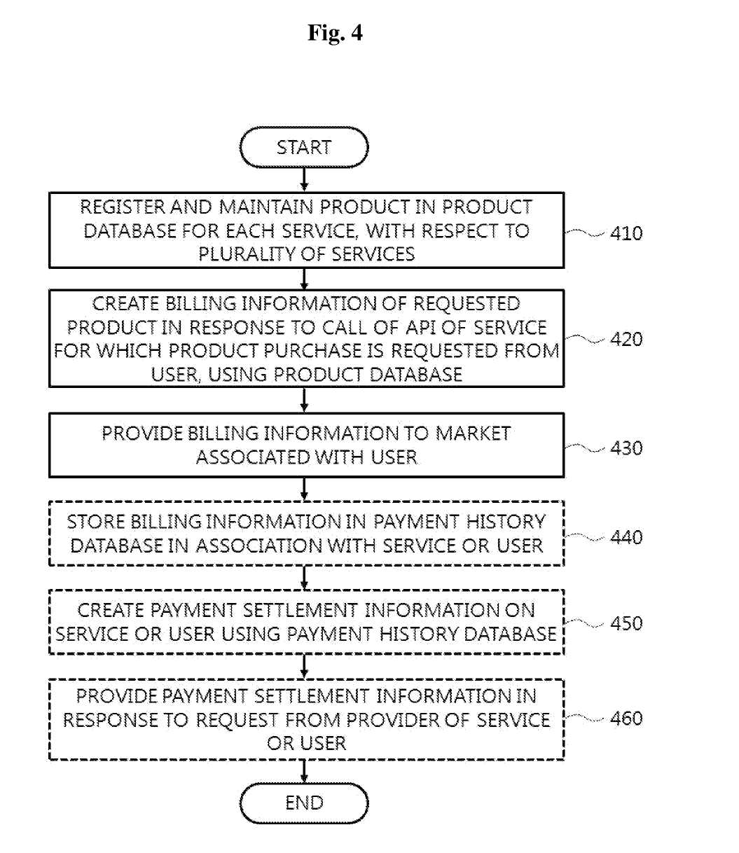

FIG. 4 is a flowchart illustrating an example of a payment service method according to an embodiment. The payment service method may be performed by a payment service system configured to provide a payment function to a service server according to an embodiment.

For example, the payment service system of the embodiments may correspond to the payment service system 200 of FIG. 2. The payment service system may include at least one storage unit and at least one processor. Each of operations included in the payment service method may be performed by the payment service system or the at least one processor included in the payment service system. An example in which the payment service system performs each of the operations will be described with reference to FIG. 4.

In operation 410, the payment service system may register and maintain a product in a product database for each service, with respect to a plurality of services. Here, the product database may be stored in the at least one storage unit/storage. Depending on necessity, the payment service system may further maintain information on markets. Information on the markets may be stored and maintained using a separate database, or may be stored and maintained in the product database in association with a product.

In operation 420, the payment service system may create billing information of a requested product in response to a call of an API of a service for which a product purchase is requested from a user, using the product database. As described above, a service developer may be provided with a payment function provided through a payment service system by calling an API, without constructing a separate payment service function. Here, the payment service system may create billing information for the payment of the requested product using the product database.

In operation 430, the payment service system may provide the billing information to a market associated with the user. Here, a payment according to a product purchase may be processed at the market associated with the user based on the billing information. Information on the processed payment may be provided to the payment service system and a service server that provides the service to the user.

Operations 440 through 460 may be selectively performed depending on embodiments.

In operation 440, the payment service system may store the billing information or payment information created at the market in a payment history database in association with the service or the user. Here, the payment history database may also be stored in the at least one storage unit included in the payment service system.

In operation 450, the payment service system may create payment settlement information on the service or the user using the payment history database.

In operation 460, the payment service system may provide the payment settlement information in response to a request from a provider of the service or the user. As described above, in the related art, a service developer may need to directly configure a payment function and thus, all of payment information and billing information may need to be managed at the service server that provides the service. In this case, the service developer may need to configure a settlement function in person in order to create payment settlement information. In contrast, according to embodiments, a payment settlement function as well as a payment function may be integrally supported for a plurality of services and thus, developers may concentrate solely on the development of a service.

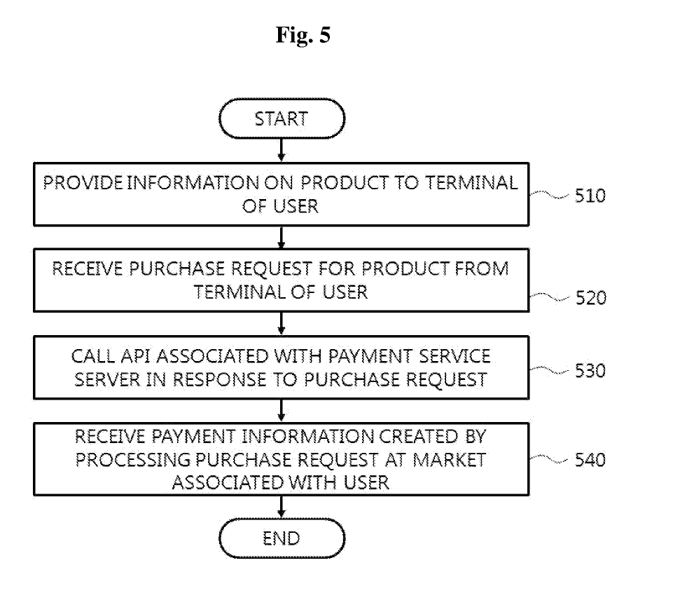

FIG. 5 is a flowchart illustrating another example of a payment service method according to an embodiment. The payment service method according to an embodiment may be performed by a service server configured to provide a service to a terminal of a user and to communicate with the payment service system 200 of FIG. 2 for payment of a product that the user desires to purchase.

The service server according to the embodiments may include at least one storage unit and at least one processor. Each of operations included in the payment service method may be performed by the service server or the at least one processor included in the service server. An example in which the service server performs each of the operations will be described with reference to FIG. 5.

In operation 510, the service server may provide information on a product to a terminal of a user. For example, when a service being provided is a game service, a game server corresponding to a service server that provides the game service may provide information on products, such as game items and cyber money, to the terminal of the user.

In operation 520, the service server may receive a purchase request for the product from the terminal of the user. In the above example, information on the products may be displayed on a screen of the terminal of the user. The user may select at least one product from among the displayed products and may make a request for purchasing the selected at least one product. The service server may receive the purchase request from the terminal in response to the selection of the user.

In operation 530, the service server may call an API associated with a payment service server in response to the purchase request. The payment service server may correspond to the payment service system 200 of FIG. 2. The payment service server may provide a payment function to a plurality of servers that provides a plurality of services, respectively. When the payment function is required, each of the service servers may use the payment function by calling the API.

In this case, the payment service server may create billing information using the product database in response to the call of the API, and may provide the created billing information to the market associated with the user. A product may be registered and maintained in the product database for each service, with respect to a plurality of services.

The market may process a payment of the product in response to the purchase request from the user, using the billing information, may create payment information, and may provide the created payment information to each of the service server and the payment service server.

In operation 540, the service server may receive payment information created by processing the purchase request at the market associated with the user.

As described above, according to embodiments, on the side of a service, it is possible to simply process a product payment through call of an API for payment, without a need to construct a separate payment system for each service, by constructing a payment system capable of integrally processing a payment related process with respect to a variety of services, and by providing the API to developers.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

While certain embodiments and implementations have been described herein, other embodiments and modifications will be apparent from this description. Accordingly, the disclosure is not limited to such embodiments, but rather to the broader scope of the presented claims and various obvious modifications and equivalent arrangements.

What is claimed is:

1. A payment service method embodied in a computer to provide a payment service, the method comprising:
registering and maintaining a product in a product database maintained in the computer for each service, with respect to a plurality of services;
creating billing information of a requested product in response to a call of an application program interface (API) of a service for which a product purchase is requested from a user, using the product database; and
providing the billing information to a market associated with the user,
wherein a payment according to the product purchase is processed at the market based on the billing information.

2. The method of claim 1, further comprising:
storing the billing information or payment information created at the market in a payment history database in association with the service or the user; and
creating payment settlement information on the service or the user using the payment history database.

3. The method of claim 2, further comprising:
providing the payment settlement information in response to a request from a provider of the service or the user.

4. A payment service method embodied in a computer to provide a payment service, the method comprising:
providing information on a product to a terminal of a user;
receiving a purchase request for the product from the terminal of the user;
calling an application program interface (API) associated with a payment service server in response to the purchase request; and
receiving payment information created by processing the purchase request at a market associated with the user,
wherein the payment information is created at the market based on billing information that is created at the payment service server using a product database in response to the call of the API, and a product is registered and maintained in the product database for each service, with respect to a plurality of services.

5. Non-transitory computer-readable media storing a program to implement the method of claim 1.

6. A payment service system, comprising:
storage configured to store a product database in which a product is registered and maintain for each service, with respect to a plurality of services; and
at least one processor,
wherein the at least one processor is configured to perform
a process of creating billing information of a requested product in response to a call of an application program interface (API) of a service for which a product purchase is requested from a user, using the product database, and
a process of providing the billing information to a market associated with the user, and
a payment according to the product purchase is processed at the market based on the billing information.

7. The payment service system of claim 6, wherein the storage is configured to further store a payment history database in which the billing information or payment information created at the market is stored and managed in association with the service or the user, and
the at least one processor is configured to further perform a process of creating payment settlement information on the service or the user using the payment history database.

8. The payment service system of claim 7, wherein the at least one processor is configured to further perform a process of providing the payment settlement information in response to a request from a provider of the service or the user.

9. A payment service system, comprising:
storage configured to store information on a product; and
at least one processor,
wherein the at least one processor is configured to perform
a process of providing information on the product stored in the storage to a terminal of a user,
a process of receiving a purchase request for the product from the terminal of the user,
a process of calling an application program interface (API) associated with a payment service server in response to the purchase request, and
a process of receiving payment information created by processing the purchase request at a market associated with the user, and
the payment information is created at the market based on billing information that is created at the payment service server using a product database in response to the call of the API, and a product is registered and maintained in the product database for each service, with respect to a plurality of services.
